(19) United States
(12) Patent Application Publication
(10) Pub. No.: US 2026/0036219 A1
(43) Pub. Date: Feb. 5, 2026

(54) FLOW CONTROL VALVE

(71) Applicant: SVM Schultz Verwaltungs-GmbH & Co. KG, Memmingen (DE)

(72) Inventors: Peter Baumgartl, Erkheim (DE); Bastian Kusterman, Benningen (DE)

(21) Appl. No.: 19/288,703

(22) Filed: Aug. 1, 2025

(30) Foreign Application Priority Data
Aug. 2, 2024 (DE) 10 2024 122 203.4

(51) Int. Cl. F16K 31/10; F16K 31/06

(52) U.S. Cl. CPC F16K 31/10; F16K 31/0675

(57) ABSTRACT

An electromagnetically actuable flow control valve with a pressure equalization space delimited by a tappet of the valve.

### CROSS-REFERENCE TO RELATED APPLICATIONS

This non-provisional application claims the benefit of, and priority to, German Application No. 10 2024 122 203.4, filed on Aug. 2, 2024, which is incorporated by reference in its entirety.

### FIELD OF THE DISCLOSURE

The present disclosure generally relates to flow control valves.

### BACKGROUND

A flow control valve is used for the regulation of a fluid quantity. Requirements are therefore a high control accuracy and reproducibility, and a low leakage in the closed state. Furthermore, flow control valves are intended to be inexpensive and to have low actuating forces. Known flow control valves cannot, however, satisfy these requirements or can satisfy them only to an unsatisfactory extent.

### SUMMARY

An electromagnetically actuable flow control valve having a central longitudinal axis can include: a valve part having an inlet and an outlet; a valve seat enclosing a main nozzle and arranged in flow terms between the inlet and the outlet in the valve part; an armature arranged to move linearly along the central longitudinal axis; a coil energized selectively to generate a magnetic field for moving the armature along the central longitudinal axis; an armature preloading device; a tappet including a pilot control bore with a pilot control nozzle, wherein the tappet is arranged adjustably in the valve part to move linearly along the central longitudinal axis between a closed position and an open position, wherein the tappet and the armature move relative to one another; a pressure equalization space which is delimited by the tappet, wherein the pilot control bore connects the inlet fluidically to the pressure equalization space; and a pilot control bore sealing device that moves with the armature to close the pilot control bore in a contact position with the pilot control nozzle and to open the pilot control bore in an opening position.

In aspects, the tappet closes the main nozzle in the closed position. In some aspects, only the pilot control bore connects the inlet to the pressure equalization space, and the tappet can be spaced apart from the valve seat in the open position. In aspects, the armature preloading device exerts a force on the armature, and the force preloads the armature preloading device into a rest position, in which the armature transmits the force to the pilot control bore sealing device and presses the pilot control bore sealing device into the contact position. In some aspects, the armature has a driving element which, when the armature moves out of the rest position into an intermediate position, the driving element engages with the tappet after the opening position of the pilot control bore sealing device is reached. In some aspects, when the armature moves out of the intermediate position, the driving element moves the tappet out of the closed position into the open position.

Other technical features may be readily apparent to one skilled in the art from the following figures, descriptions, and claims.

### BRIEF DESCRIPTION OF THE DRAWINGS

Further features, details and advantages of the invention result from the wording of the claims and from the following description of exemplary embodiments on the basis of the drawings, in which:

FIG. 1 shows a longitudinal sectional view of a flow control valve in a first operating state,

FIG. 2 shows a longitudinal sectional view of the flow control valve in a second operating state,

FIG. 3 shows a longitudinal sectional view of the flow control valve in a third operating state,

FIG. 4 shows a detailed view of the flow control valve,

FIG. 5 shows a longitudinal sectional view of a further flow control valve in a first operating state,

FIG. 6 shows a longitudinal sectional view of the further flow control valve in a second operating state,

FIG. 7 shows a longitudinal sectional view of the further flow control valve in a third operating state, and

FIG. 8 shows a detailed view of a further flow control valve.

### DETAILED DESCRIPTION

In the figures, elements which are identical or correspond to one another are each denoted using the same reference signs and are therefore not described again, unless expedient. Features which have already been described are not described again in order to avoid repetitions, and can be applied to all elements with reference signs which are identical or correspond to one another, unless explicitly ruled out. The disclosures contained in the entire description can be transferred mutatis mutandis to identical parts with identical reference signs or identical component designations. The positional specifications selected in the description such as, for example, top, bottom, side, etc. also relate to the directly described and illustrated figure and can be transferred mutatis mutandis to the new position in the case of a positional change. Furthermore, individual features or combinations of features from the illustrated and described different exemplary embodiments can also be solutions which are independent, inventive or according to the invention.

Disclosed is an electromagnetically actuable flow control valve which is passed through by a central longitudinal axis, comprising a valve part, in which an inlet and an outlet are configured, a valve seat which encloses a main nozzle and is arranged in flow terms between the inlet and the outlet in the valve part, an armature which is arranged such that it can be moved in a linear manner along the central longitudinal axis, a coil which can be energized selectively in order to generate a magnetic field for moving the armature along the central longitudinal axis, an armature preloading device, a tappet which comprises a pilot control bore with a pilot control nozzle, and which is arranged adjustably in the valve part for movement in a linear manner along the central longitudinal axis between a closed position and an open position, wherein the tappet and the armature can be moved to a limited extent relative to one another, a pressure equalization space which is delimited by the tappet, wherein the pilot control bore connects the inlet fluidically to the pressure equalization space, a pilot control bore sealing device which can be moved with the armature in order to close the pilot control bore in a contact position with the pilot control nozzle and in order to open the pilot control bore in an opening position, wherein the tappet closes the main nozzle in the closed position, with the result that only the pilot control bore can connect the inlet to the pressure equalization space, and the tappet is spaced apart from the valve seat in the open position, wherein the armature preloading device exerts a force on the armature, which force preloads it into a rest position, in which the armature transmits this force to the pilot control bore sealing device and presses the pilot control bore sealing device into its contact position, wherein the armature has a driving element which, in the case of movement of the armature out of its rest position into an intermediate position, comes into engagement with the tappet after the opening position of the pilot control bore sealing device is reached, wherein, in the case of a further movement of the armature out of the intermediate position, the driving element moves the tappet out of its closed position into its open position.

No throughflow is possible in the closed state of the flow control valve. The pilot control bore sealing device and the tappet make advantageous two-stage opening of the flow control valve possible. In the closed state of the flow control valve, the tappet is in its closed position, the pilot control bore sealing device is in its contact position, and the armature is in its rest position.

First of all, only the pilot control bore is open for pilot control, to be precise by virtue of the fact that the coil is energized, the armature is attracted, and the pilot control bore sealing device is distanced from the pilot control nozzle of the pilot control bore out of its contact position. The pilot control bore is then fluidically opened and connects only the inlet and the pressure equalization space. In this state, furthermore, the inlet and the outlet are not connected. In the pilot control, the tappet is in its closed position, the pilot control bore sealing device is in its opening position, and the armature is in its intermediate position.

Fluid then flows through the pilot control bore into the pressure equalization space. The pressure which then prevails against the tappet in the pressure equalization space generates a movement in the direction of the open position of the tappet. As a result, the force to be applied by the coil for the movement of the tappet into the open position can be low.

A fluidic connection between the inlet and the outlet is established only in the case of the opening of the main nozzle, and to be precise by virtue of the fact that the tappet is spaced apart from the main nozzle or lifts up from the main nozzle by way of corresponding energization of the coil. This lifting movement is proportional to the current strength and therefore also proportional to the volumetric flow. In this state, the tappet is pressure-equalized; this means that the forces which act on both sides along the central longitudinal axis cancel each other out. In the open state of the flow control valve, the tappet is in its open position and possibly separation position, the pilot control bore sealing device is in its opening position, and the armature is in its end position.

According to the invention, a low actuating force during opening of the flow control valve is realised by way of a fluid path between the inlet, the pilot control bore and the pressure equalization space. In the case of a closed main nozzle, the fluid can flow into the pressure equalization space, wherein merely a low force is required to open the main nozzle as a result of this pressure assistance on one side or second pressure surface of the tappet. By virtue of the fact that the tappet closes the main nozzle in the closed position, with the result that only the pilot control bore can connect the inlet to the pressure equalization space, the fluid pressure up to opening of the main nozzle is used exclusively for the pressure assistance. As a result of this design of the flow control valve, a pressure equalization is achieved during opening of the pilot control bore. The flow control valve is a pressure-equalized valve when the main nozzle is open. For this reason, low actuating forces, a satisfactory control capability and a low installation space are achieved.

Furthermore, the construction has the advantage that the contact position of the pilot control bore sealing device on the tappet is defined in an unambiguous and reproducible manner. No change in the position or impairment in the leakage value is to be expected during the course of the service life either.

The inlet and/or the outlet can be part of the flow control valve and/or can be configured in the valve part. The valve part can be configured in one piece, for example, in a monolithic manner. As a result, connecting points and leakage possibilities are ruled out, which further boosts these advantages precisely with regard to the method of operation of the pressure equalization space. Furthermore, this reduces the number of required components and lowers assembly costs. As an alternative, the valve part can be configured in multiple pieces. In aspects, the back-pressure space is configured exclusively by the tappet, the valve part and a cover of the valve part. The cover leaves access to the back-pressure space open, via which components can be introduced during assembly.

The flow control valve has the valve seat which encloses the main nozzle and is arranged in flow terms between the inlet and the outlet in the valve part. Here, the main nozzle is an opening within the valve part, through which opening fluid is intended to flow only when the valve is open. The flow control valve can comprise a core of the electromagnet, to which the valve part is fastened.

The valve part can be arranged within a valve body, can be a separate part with respect to the former, and can be sealed with respect to the former. The valve part is arranged in the fluid path between the inlet and the outlet and is immovable with respect to the valve body. In some embodiments, the valve part receives the tappet, and in some further embodiments, exclusively.

The flow control valve can comprise an electromagnet. The flow control valve has an armature which is arranged for movement in a linear manner along the central longitudinal axis. This means that the armature can move in a linear manner along the central longitudinal axis between two predefined end positions (rest position and end position).

The flow control valve has a coil which generates a magnetic field for the movement of the armature along the central longitudinal axis in the case of an electric current selectively flowing through it. As a result, the armature can be moved actively, wherein forces can typically be generated in both possible directions by way of reversing the polarity.

The valve has the tappet which can support at least one annular seal and which is arranged in the valve part for movement in a linear manner along the central longitudinal axis between the closed position and the open position, wherein the tappet and the armature can be moved relative to one another, preferably to a limited extent. The tappet can therefore be moved along the same spatial direction as the armature. The tappet can be guided via its outer circumferential surface. In some embodiment, the tappet is guided by the valve part, and in some embodiments, only by the valve part. As a result, tilt-free guidance can be ensured and reliable sealing can be achieved by way of the at least one annular seal.

The armature preloading device exerts a force on the armature, which force preloads it into the rest position. In the rest position, the armature transmits the force to the pilot control bore sealing device, wherein this force presses the tappet into the closed position, and the pilot control bore sealing device closes the pilot control bore. The rest position can correspond here to that position which the armature assumes when no magnetic field generated by the coil exerts a force on it. The armature preloading device ensures that the armature assumes the rest position in this case. For the case where the coil should undesirably become deenergized, the armature preloading device can fulfil a safety function by closing the main nozzle.

The armature has a driving element which passes into engagement with the tappet in the case of movement of the armature out of the rest position into the intermediate position after opening of the pilot control bore. In the intermediate position of the armature, the pilot control bore is therefore open, which makes pressure equalization between the inlet and the pressure equalization space possible, but does not yet make any volumetric flow to the outlet possible. The pressure equalization facilitates the subsequent removal of the tappet from the valve seat of the main nozzle.

In accordance with one refinement, the armature can have the pilot control bore sealing device on the tappet side. The pilot control bore sealing device can be a sealing nipple. The armature or its armature main body therefore has a separate component for sealing. The armature and the pilot control bore sealing device can therefore be made from different materials, which is advantageous if the pilot control bore sealing device is intended to be manufactured from a non-magnetic material, for example an elastomer. As an alternative, the pilot control bore sealing device can be an armature longitudinal end. The armature longitudinal end can therefore be formed by the armature itself, whereby a multiple-piece nature is avoided.

In accordance with one embodiment, the pressure equalization space can have the pilot control bore as the only fluidic connection, and/or the pilot control bore can have exclusively two openings. This ensures the pressure equalization function in high quality since the entire fluid which flows out of the inlet into the pilot control bore can flow into the pressure equalization space for the pressure equalization. As a result, the pressure build-up in the pressure equalization space and the adjustment of the tappet into its open position are coupled directly to one another. Furthermore, the pilot control bore can advantageously have exclusively two openings, wherein one opening can open to the pressure equalization space and the other opening fluidically faces the inlet and/or can open into a pilot control space. As a result, fluidic bypasses which can lead to efficiency disadvantages are avoided.

In accordance with one embodiment, the pressure equalization space can be configured exclusively by the tappet and the valve part. The pressure equalization space can be configured on the valve part side exclusively by a single-piece portion of the valve part. By virtue of the fact that that portion of the valve part which delimits the pressure equalization space is in one piece, connecting points and resulting leakage risks are avoided. Furthermore, the number of required components is reduced and assembly is simplified as a result.

In accordance with one embodiment, the pressure equalization space can be delimited without sealing devices. A sealing device can be, for example, a sealing ring made from an elastic material. A dedicated sealing device can advantageously be dispensed with.

In accordance with one embodiment, the pressure equalization space can be arranged along the central longitudinal axis on that side of the tappet which lies opposite the pilot control bore sealing device. This serves for a narrow overall design. Furthermore, the pressure force which prevails against the tappet in the pressure equalization space can act in the direction of the open position of the tappet.

In accordance with one embodiment, the valve part can have a bore with a constant diameter along the central longitudinal axis on the side of the main nozzle where the pressure equalization space is present. A bore of this type can be produced in a simple way and inexpensively. The bore can be a non-stepped blind bore and/or can extend along the central longitudinal axis between the main nozzle and a wall of the valve part which delimits the pressure equalization space. As a result, a disadvantageous step-induced space is additionally avoided, since the adjustment of the tappet into its open position might then take place counter to the fluid pressure in this step-induced space, as a result of which an opening movement of the tappet is made more difficult.

In accordance with one embodiment, the tappet can have a first pressure surface which is exposed to fluidic pressure which prevails from the inlet, and/or can have a second pressure surface which is exposed to fluidic pressure which prevails from the pressure equalization space. As a result, the tappet can be adjusted in a manner which is due to the fluid pressure. The first pressure surface can be arranged in such a way that the fluid pressure can press the tappet into the closed position or can at least apply a force which acts into the closing position. The second pressure surface can be arranged in such a way that the fluid pressure can press the tappet into the open position or can at least apply a force which acts into the opening position. The second pressure surface can delimit the pressure equalization space. In some embodiments, the two pressure surfaces are arranged on end sides which lie opposite one another with regard to the tappet and/or run parallel to one another and/or run perpendicularly with respect to the central longitudinal axis. As a result, the fluid pressure can serve in an optimum manner for an adjusting movement.

In accordance with one embodiment, the first pressure surface can have a size which lies in the range from 6 times to 10 times the cross section of the inlet, through which flow can pass. In some embodiments, the size can be 8 times as large. As a result, a great surface area is realised, on which fluid pressure flowing in from the inlet can prevail. The prevailing fluid pressure generates a force on the tappet which acts in the direction of its closing direction and assists with it staying in the closing direction. As a result, a safety closure function can be realised and ensured in the closed, non-energized state. The tappet advantageously namely also remains in its closed position should a preloading device which preloads it fail.

In accordance with one embodiment, the second pressure surface can have a size which lies in the range from one time to 8 times the cross section of the inlet, through which flow can pass. In some embodiments, the size can be 2.5 times as large. As a result, a great surface area is realised, on which fluid pressure prevailing from the pressure equalization space can prevail.

In accordance with one embodiment, the first pressure surface can have a size which lies in the range from one time to 5 times the size of the second pressure surface. In some embodiments, the size can be 3 times as large.

In accordance with one embodiment, the smallest cross section of the pilot control bore, through which flow can pass, can have a size which lies in the range from 1 time to 0.25 times the cross section of the inlet, through which flow can pass. In some embodiments, the size can be 0.5 times as large.

In accordance with one embodiment, on the outer circumferential side, the tappet can have an annular channel which, in the open position, connects the inlet to the outlet. In some embodiments, only the annular channel can connect the inlet to the outlet in the open position. The exclusive connection avoids bypasses which impair the efficiency. The annular channel can be a main flow space. The annular channel and/or main flow space connect/connects the inlet to the outlet in a structurally highly simple way. The annular channel can define the resulting nominal width of the flow control valve, wherein different nominal widths can be set, in the case of an otherwise identical flow control valve, by way of the structural configuration of the tappet. For example, the external diameter of a trunk portion of the tappet can be structurally adapted in a corresponding manner.

In accordance with one embodiment, the fluid conducting portion can be of T-shaped configuration as viewed in a longitudinal section. In embodiments, the fluid conducting portion comprises a top coat portion and/or a trunk portion. The portions can be arranged adjacently with respect to one another along the central longitudinal axis.

The top coat portion can be a circular ring portion and advantageously separate two spaces within the valve part interior space (for example, pilot control space and main flow space). The top coat portion can support a first annular seal on its side which faces the pilot control bore sealing device. The first annular seal can serve to reliably close the pilot control nozzle. The top coat portion can support a second annular seal on its side which faces the main nozzle. The second annular seal can serve to reliably close the main nozzle. The pilot control bore can extend through the top coat portion, wherein this serves a compact overall design. The top coat portion can configure the first pressure surface on its side which faces away from the main nozzle. In embodiments, the top coat portion extends transversely with respect to the central longitudinal axis. In embodiments, the top coat portion is mounted with a plain bearing on the valve part, and in some cases, without a sealing device. This serves to reliably guide the tappet and for the fluidic disconnection of spaces which are separated from one another.

The trunk portion can extend along the central longitudinal axis and can adjoin the top coat portion. The pilot control bore can extend through the trunk portion, wherein this serves a compact overall design. The trunk portion can delimit the annular channel and/or main flow space by way of its outer circumferential side.

In accordance with one embodiment, the tappet can have a circular ring portion which divides the valve part interior space into a pilot control space and a main flow space, wherein the circular ring portion is adjusted or can be adjusted by way of the tappet with respect to the inlet in such a way that it selectively
opens a fluidic connection between the inlet and the pilot control space, and disconnects a fluidic connection between the inlet and the outlet through the main flow space, or
disconnects a fluidic connection between the inlet and the pilot control space or at least reduces the throughflow in comparison with the opened state, and opens a fluidic connection between the inlet and the outlet through the main flow space, and the tappet can be adjusted into a disconnecting position as a result.

The fluid which flows in from the inlet can thus be conducted, in a manner dependent on the position of the circular ring portion, either into the pilot control space for pilot control or into the main flow space for main throughflow. The circular ring portion can be the top coat portion. That position of the circular ring portion which was mentioned first in the preceding text can be present in the closed position and/or opening position. That position of the circular ring portion which was mentioned last in the preceding text can be present in the open position. It can therefore be prevented precisely in the open position that fluid continues to run into the pilot control bore and thus reduces the main throughflow from the inlet to the outlet. In some embodiments, the circular ring portion can be positioned along the central longitudinal axis and with regard to the inlet, in order to partially cover the inlet or to be adjusted past it. The open position of the tappet can be identical to its disconnecting position.

In accordance with one embodiment, the tappet can be guided with a plain bearing without a sealing device, for example on the valve part. This serves to avoid sliding friction due to the sealing device and makes low adjusting forces possible. The tappet is guided precisely in the valve part with respect to the main nozzle by its own guide surfaces. A sealing device can be, for example, a sealing ring made from an elastic material. A dedicated sealing device can advantageously be dispensed with. The guide surfaces can be configured by the top coat portion of a pressure equalization space bounding portion. In some embodiments, the tappet has two guide surfaces.

In accordance with one embodiment, the tappet can support a first annular seal which serves to seal the pilot control nozzle, and can support a second annular seal which serves to seal the main nozzle. In the contact position, the pilot control bore sealing device can bear against the first annular seal. In the opening position, the pilot control bore sealing device can be spaced apart from the first annular seal. In the closed position, the second annular seal can bear against the main nozzle. In the open position, the second annular seal can be spaced apart from the main nozzle. The first annular seal can configure the pilot control nozzle. As a result, the tappet can support the seals for the two nozzles and can fulfil a dual function. The annular seals can be elastomer seals and/or can be vulcanized on, preferably in one piece.

In accordance with one embodiment, the tappet can be configured in one piece or in multiple pieces. In the single piece configuration, the tappet can be monolithic. As a result, connecting points and leakage possibilities are ruled out, which further boosts these advantages precisely with regard to the method of operation of the pressure equalization space. Furthermore, this reduces the number of required components and lowers assembly costs. In the multiple-piece configuration, the tappet can comprise a driving portion and/or a fluid conducting portion and/or a pressure equalization space bounding portion. The portions can be separate from one another. The driving portion can be driven by the driving element, in order to move the tappet into its open position. The fluid conducting portion can comprise the pilot control bore. The pressure equalization space bounding portion can delimit the pressure equalization space. The driving portion can be arranged on the fluid conducting portion, and the driving portion and the fluid conducting portion can be clipped to one another or fastened to one another by means of a tongue-groove connection. Clipping is advantageous if the driving portion and/or the fluid conducting portion comprise/comprises plastic. The pressure equalization space bounding portion can be arranged on the fluid conducting portion, and the pressure equalization space bounding portion and the fluid conducting portion can be pressed onto one another, adhesively bonded or bear loosely against one another. In some embodiments, the fastening spring presses the portions which bear loosely against one another together. As a result, the portions which bear loosely against one another can be held together securely. The fastening spring can be supported between the valve part or the cover and the tappet.

The pressure equalization space bounding portion can be a circular ring portion or a sleeve, or a sleeve with an inner flange. The pressure equalization space bounding portion can advantageously separate two spaces within the valve part interior space from one another (for example, pressure equalization space and annular channel and/or main flow space). The pressure equalization space bounding portion can define the pressure equalization space-side end of the tappet, partially or completely. The pressure equalization space bounding portion can configure the second pressure surface on its side which faces the pressure equalization space. In some embodiments, the pressure equalization space bounding portion extends, in some cases completely, as a circular ring portion transversely with respect to the central longitudinal axis. In some embodiments, the pressure equalization space bounding portion is mounted with a plain bearing on the valve part, and in some embodiments, without a sealing device. This serves for secure guidance of the tappet and the fluidic disconnection of spaces which are separated from one another. In some embodiments, the pressure equalization space bounding portion is flush with the outlet without a step in the open position. This avoids turbulence in the annular channel or main flow space. The inner flange can delimit the pilot control bore, and/or the pilot control bore can open into the back-pressure space. In some embodiments, the inner flange bears on the end side against the fluid conducting portion. The sleeve can be arranged on the outer circumferential side of the fluid conducting portion.

In accordance with one embodiment, the flow control valve can comprise a tappet preloading device which preloads the tappet into its closed position. As a result, a safety function in the case of power failure and a spring fracture is realised. The tappet preloading device can be supported between a supporting point, which is immovable with regard to the valve part, and the tappet. On account of the supporting point, the preload by way of the tappet preloading device is independent of the preload by way of the armature preloading device. The armature preloading device and the tappet preloading device can load the tappet with pressure in the same spatial direction. There is dual safety against opening of the flow control valve: The armature preloading device presses the tappet into its closed position and, as a result, prevents opening of the main nozzle, and the tappet preloading device presses the tappet into its closed position and, as a result, prevents opening of the main nozzle. Even if one of the two preloading devices fails, undesired opening of the valve is prevented. The supporting point can be configured by a flange ring which can be fastened to the core or to the housing of the flow control valve or to the valve part. The flange ring can be pressed or adhesively bonded there.

In accordance with one embodiment, the outlet can run in a tilted manner with respect to the central longitudinal axis. The outlet can be tilted in such a way that a fluid path which leads into the outlet has an angle in the range from 120° to 150°, for example, an angle of 135° as a result of the tilting. As a result, a pressure loss can be optimized and a compact overall design can be realised. The fluid path can lead from the bore in the valve part or main flow space directly into the outlet.

Should components be disclosed multiple times, embodiments and advantages which are described only for one of the components are intended as it were to be considered as also disclosed in an optional way for the other corresponding components. Axial and axial direction run parallel to the central longitudinal axis. Radial and radial direction run perpendicularly with respect to the central longitudinal axis. Circumference and circumferential direction run around the centrifugal longitudinal axis.

A radial direction R extends perpendicularly with respect to a central longitudinal axis A. A circumferential direction extends around the central longitudinal axis A, and a transverse centre plane is arranged in such a way that its perpendicular vector lies on the central longitudinal axis.

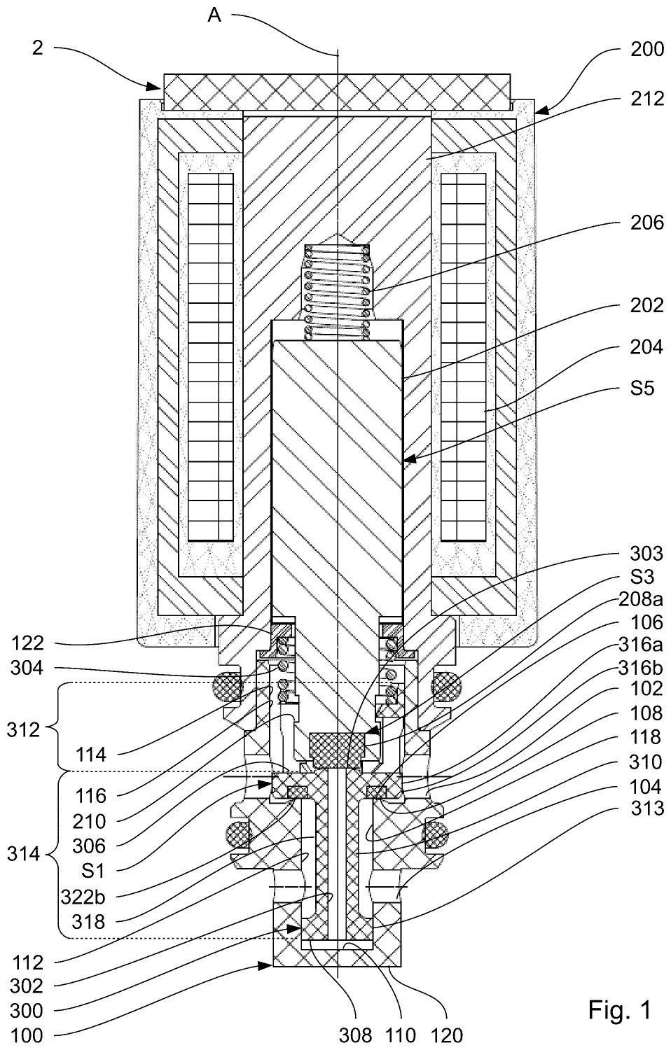

All of FIGS. 1 to 4 show a single flow control valve 2, for which reason each feature in each figure is not described again. Features which have already been described but are not repeated again are intended to be considered as it were as disclosed and described.

The flow control valve 2 is penetrated by a central longitudinal axis A and comprises a single-piece valve part 100. An inlet 102 and an outlet 104 are configured in the valve part 100. The valve part 100 configures a valve part interior space 114, in which a pressure equalization space 110, a pilot control space 116 and a main flow space 118 are arranged. Furthermore, the valve part 100 configures a valve seat 106 which encloses a main nozzle 108 and is arranged in flow terms between the inlet 102 and the outlet 104 in the valve part 100.

The flow control valve 2 additionally comprises an electromagnet 200 in the structural form of a linear magnet. The electromagnet 200 comprises an armature 202 which is arranged such that it can be moved in a linear manner along the central longitudinal axis A, and a coil 204 which can be energized selectively in order to generate a magnetic field for the movement of the armature 202. The armature 202 is loaded with force by an armature preloading device 206. Furthermore, a core 212 is provided, to which the valve part 100 is fastened. The electromagnet 200 additionally comprises an elastomeric pilot control bore sealing device 208a which is separate from the armature 202, is configured as a sealing nipple, is fastened to the armature and can be moved with the armature 202.

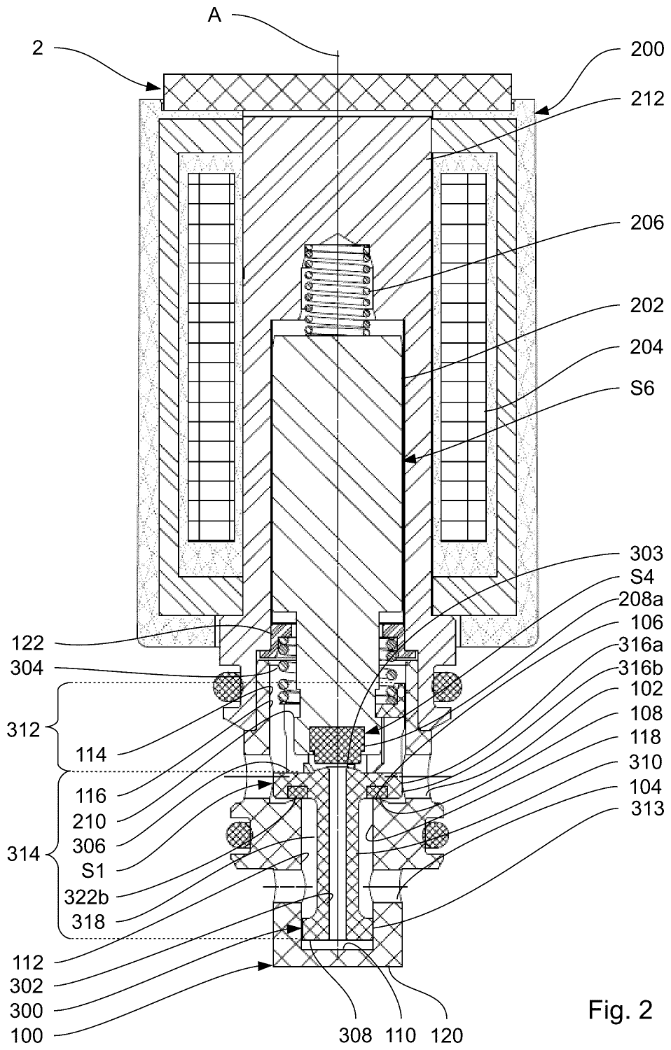

Furthermore, the flow control valve 2 comprises a single-piece tappet 300 in the valve part 100. The tappet 300 is arranged adjustably in the valve part 100 for movement in a linear manner along the central longitudinal axis A between a closed position S1 and an open position S2, and can be moved to a limited extent relative to the armature 202. The tappet 300 is guided with a plain bearing on the valve part 100, without a sealing device. In the closed position S1, the tappet 300 closes the main nozzle 108, with the result that only a pilot control bore 302 can connect the inlet 102 to the pressure equalization space 110 (FIG. 2). A tappet preloading device 304 which preloads the tappet 300 into its closed position S1 is supported between the tappet 300 and a supporting point which is configured by a flange ring 122 which is fastened to the core 212.

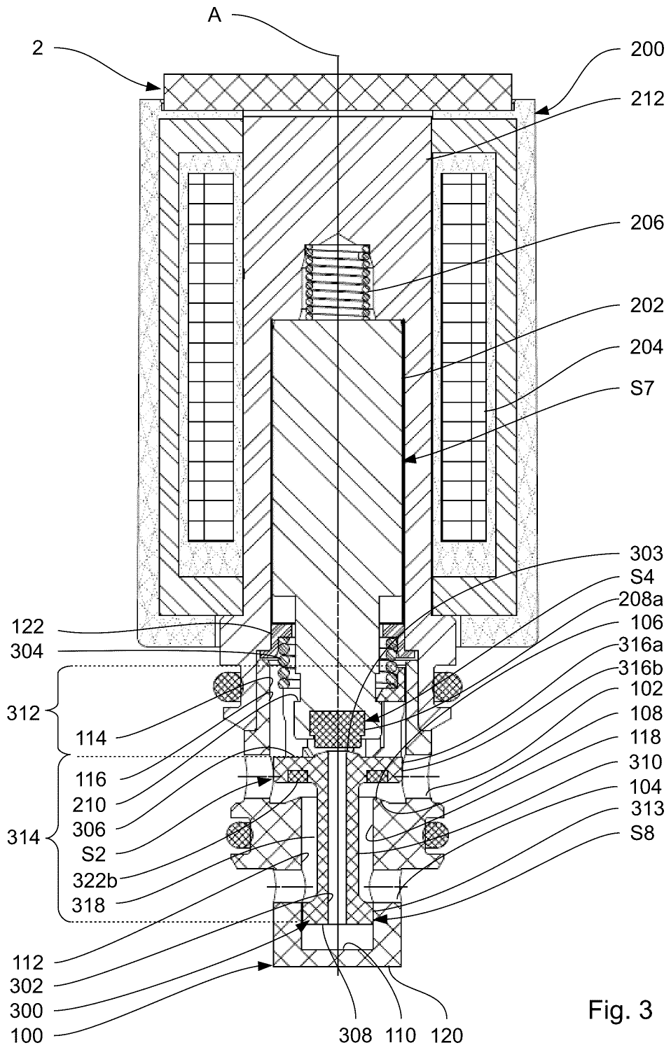

In the open position S2, the tappet 300 is spaced apart from the valve seat 106, with the result that the inlet 102 is connected fluidically to the outlet 104 (FIG. 3). The tappet 300 has a first pressure surface 306 which is exposed to fluid pressure which prevails from the inlet 102, and a second pressure surface 308 which is exposed to fluid pressure which prevails from the pressure equalization space 110. The two pressure surfaces 306, 308 are arranged on end sides which lie opposite with regard to the tappet 300, and run parallel to one another and perpendicularly with respect to the central longitudinal axis A. The second pressure surface 308 delimits the pressure equalization space 110.

The tappet 300 configures a pilot control bore 302 which extends along the central longitudinal axis A and connects the inlet 102 and the pilot control space 116 fluidically to the pressure equalization space 110. The pilot control bore 302 comprises a pilot control nozzle 303, and is closed by the pilot control bore sealing device 208a in a contact position S3 and can be flowed through fluidically in an opening position S4 of the pilot control bore sealing device 208a. The tappet 300 has, on the outer circumferential side, an annular channel 310 which connects the inlet 102 to the outlet 104 in the open position S2.

The tappet 300 comprises a driving portion 312, a pressure equalization space bounding portion 313 and a fluid conducting portion 314. The driving portion 312 is driven by the driving element, in order to move the tappet 300 into its open position. The fluid conducting portion 314 is of T-shaped configuration as viewed in a longitudinal section, and comprises a top coat portion 316a and a trunk portion 318 along the central longitudinal axis A in this sequence.

The top coat portion 316a is a circular ring portion 316b and divides the pilot control space 116 from the main flow space 118. On its side which faces the main nozzle 108, the top coat portion 316a supports a second annular seal 322b and, on its side which faces away from the main nozzle 108, configures the first pressure surface 306. The top coat portion 316a extends completely transversely with respect to the longitudinal axis A and is mounted with a plain bearing on the valve part 100, without a sealing device.

The trunk portion 318 extends along the central longitudinal axis A and adjoins the top coat portion 316a. With its outer circumferential side, the trunk portion 318 delimits the annular channel 310 or main flow space 118.

The pressure equalization space bounding portion 313 is a circular ring portion and separates the pressure equalization space 110 from the annular channel 310 or main flow space 118. The pressure equalization space bounding portion 313 defines the pressure equalization space-side end of the tappet 300. The pressure equalization space bounding portion 313 configures the second pressure surface 308 on its side which faces the pressure equalization space 110. The pressure equalization space bounding portion 313 extends completely transversely with respect to the longitudinal axis A. Furthermore, it is mounted with a plain bearing on the valve part 100 without a sealing device. In the open position S2, the pressure equalization space bounding portion 313 is flush with the outlet 104 in a step-free manner (FIG. 3). The pilot control bore 302 extends along the central longitudinal axis A through all three portions 316a, 318 and 313.

The circular ring portion 316b is adjusted or can be adjusted with the tappet 300 with respect to the inlet 102 along the central longitudinal axis A and with regard to the inlet 102 in such a way that it can selectively assume two positions. The circular ring portion 316b can partially cover the inlet 102 or can be adjusted past the latter. The first position of the circular ring portion 316b is present in the closed position S1. Here, a fluidic connection between the inlet 102 and the pilot control space 116 is opened and at the same time a fluidic connection between the inlet 102 and the outlet 104 through the main flow space 118 is disconnected. The second position of the circular ring portion 316b is present in the open position S2. Here, a fluidic connection between the inlet 102 and the pilot control bore 302 through the pilot control space 116 is disconnected or a throughflow is at least reduced with respect to the opened state (first position), and a fluidic connection between the inlet 102 and the outlet 104 through the main flow space 118 or annular channel 310 is opened. The separation position S8 of the tappet is present.

The pressure equalization space 110 can be delimited exclusively by the valve part 100 and the tappet 300. Furthermore, the pressure equalization space 110 is delimited without sealing devices. The armature preloading device 206 exerts a force on the armature 202, which force preloads it into a rest position S5, in which it transmits this force to the pilot control bore sealing device 208a and presses the pilot control bore sealing device 208a into the contact position S3. The armature 202 has a driving element 210 which comes into engagement with the tappet 300 in the case of movement of the armature 202 out of its rest position S5 into an intermediate position S6 after the opening position S4 of the pilot control bore sealing device 208a is reached. In the case of further movement of the armature 202 out of the intermediate position S6, the driving element 210 moves the tappet 300 out of its closed position S1 into its open position S2. The pressure equalization space 110 has the pilot control bore 302 as the single fluidic connection. Fluid can flow into and out of the pressure equalization space 110 only via the pilot control bore 302. In some aspects, the pilot control bore 302 additionally has only two openings, wherein one thereof opens to the pressure equalization space 110 and the other opens to the pilot control space 116.

The valve part 100 has a bore 112 with a constant diameter along the central longitudinal axis A on the side of the main nozzle 108 where the pressure equalization space 110 is present. The bore 112 is a part of the valve part interior space 114. The bore 112 is a non-stepped blind bore and extends along the central longitudinal axis A between the main nozzle 108 and a wall 120 of the valve part 100 which delimits the pressure equalization space 110. The pressure equalization space 110 is arranged along the central longitudinal axis A on that side of the tappet 300 which lies opposite the pilot control bore sealing device 208a.

FIG. 1 shows that no throughflow is possible in the closed state of the flow control valve 2. In the closed state of the flow control valve 2, the tappet 300 is in its closed position S1, the pilot control bore sealing device 208a is in its contact position S3, and the armature 202 is in its rest position S5.

FIG. 2 shows the pilot control. First of all, only the pilot control bore 302 is opened for pilot control, to be precise by virtue of the fact that the coil 204 is energized, as a result of which the armature 202 is attracted and the pilot control bore sealing device 208a is lifted from the pilot control bore 302. The pilot control bore 302 is then fluidically opened and connects only the inlet 102 and the pressure equalization space 110. In this state, furthermore, the inlet 102 and the outlet 104 are not connected. In the pilot control, the tappet 300 is in its closed position S1, the pilot control bore sealing device 208a is in its opening position S4, and the armature 202 is in its intermediate position S6. Fluid then flows into the pressure equalization space 110 through the pilot control bore sealing device 208a. The pressure which then prevails against the tappet 300 in the pressure equalization space 110 generates a movement in the direction of the open position S2 of the tappet 300.

FIG. 3 shows the open flow control valve 2. A fluidic connection between the inlet 102 and the outlet 104 is established only when the main nozzle 108 is opened, to be precise by virtue of the fact that the tappet 300 is spaced apart from the main nozzle 108. In this state, the tappet 300 is pressure-equalized; this means that the forces which act on both sides along the longitudinal axis A cancel each other out. In the open state of the flow control valve, the tappet 300 is in its open position S2 and separation position S8, the pilot control bore sealing device 208a is in its opening position S4, and the armature 202 is in its end position S7.

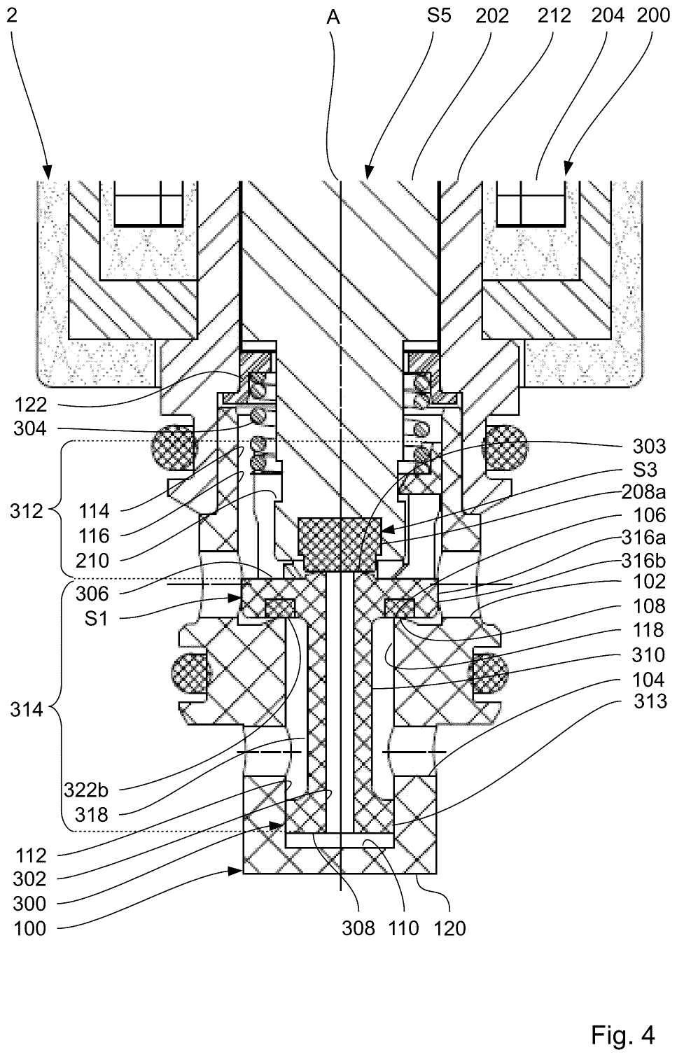

FIG. 4 shows a detailed view of FIG. 1.

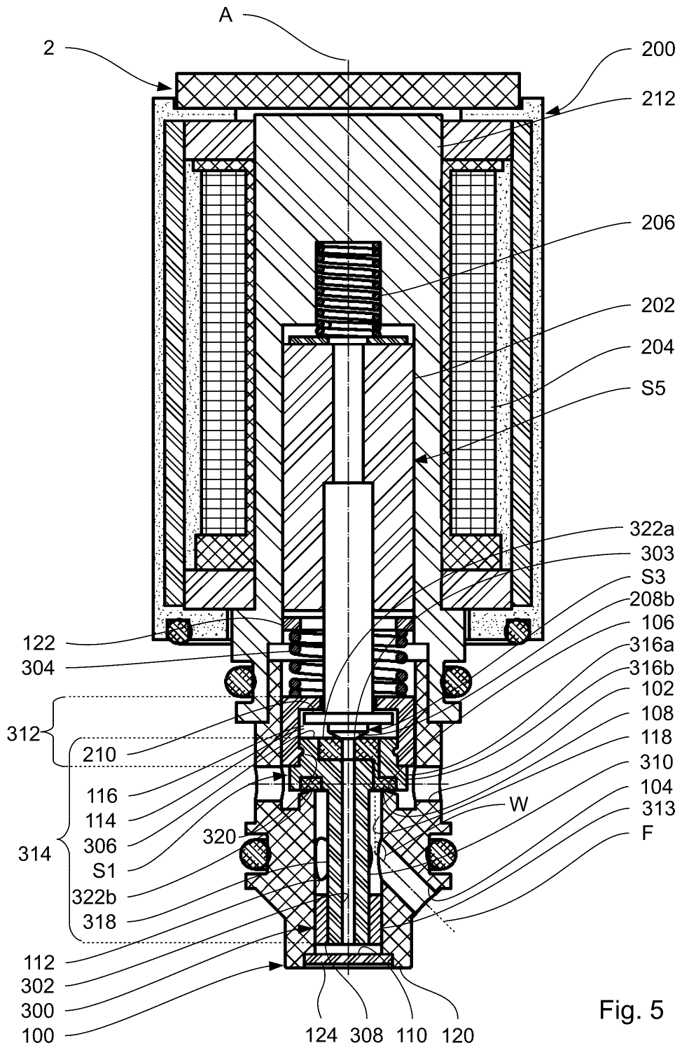

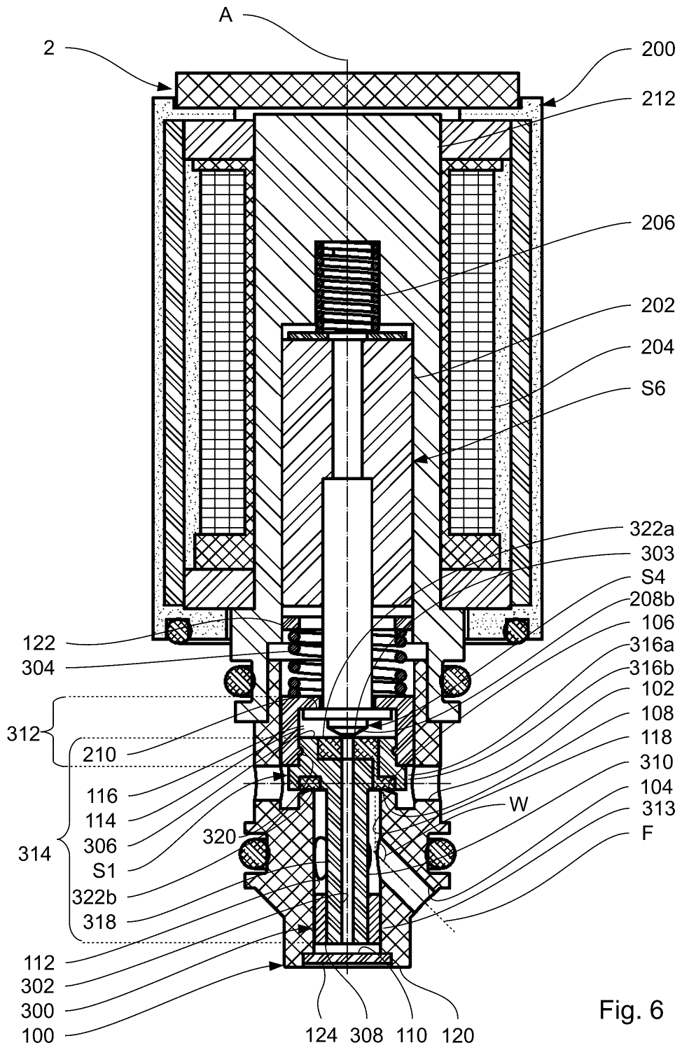

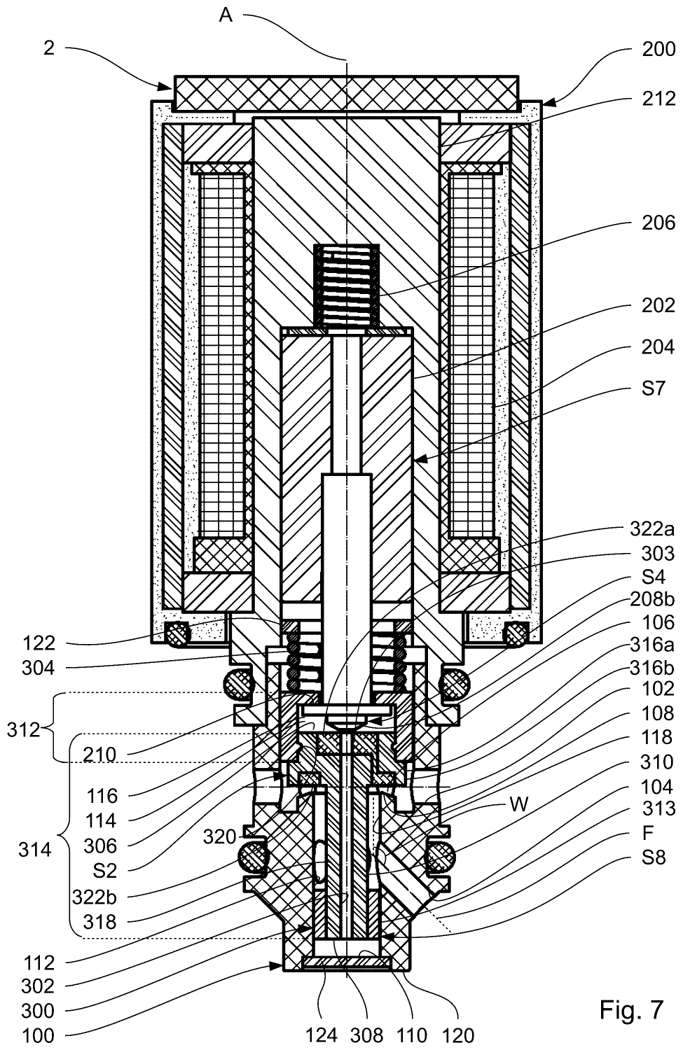

All of the FIGS. 5 to 7 show a further single flow control valve 2, for which reason each feature in each figure is not described again. Only the differences from FIGS. 1 to 4 are to be described with regard to FIGS. 5 to 7. Features which have already been described but are not repeated again are intended as it were to be considered as disclosed and described. FIG. 5 shows the closed state of the flow control valve 2, in an analogous manner to FIG. 1. FIG. 6 shows the pilot control, in an analogous manner to FIG. 2. FIG. 7 shows the open flow control valve 2, in an analogous manner to FIG. 3.

The tappet 300 is of multiple-piece configuration and comprises the separate parts of driving portion 312, fluid conducting portion 314 and pressure equalization space bounding portion 313. The driving portion 312 is clipped to the fluid conducting portion via a clip-on connection 320.

The pressure equalization space bounding portion 313 is arranged, for example pressed or adhesively bonded, on the fluid conducting portion. Furthermore, the pressure equalization space bounding portion 313 is configured as a sleeve and is arranged on the outer circumferential side of the fluid conducting portion 314.

The tappet 300 supports a first annular seal 322a which serves to seal the pilot control nozzle 303, and the second annular seal 322b which serves to seal the main nozzle 108. The first annular seal 322a configures the pilot control nozzle 303. The annular seals 322a, 322b are configured in one piece with one another and are vulcanized on.

The valve part 100 is of multiple-piece configuration and comprises a separate cover 124 which delimits the pressure equalization space 110 (also referred to as a back-pressure space). A pilot control bore sealing device 208b is then one armature longitudinal end. The outlet 104 is tilted with respect to the central longitudinal axis A. A fluid path F which leads from the bore 112 in the valve part 100 or main flow space 118 directly into the outlet 104 has an angle W of 135°.

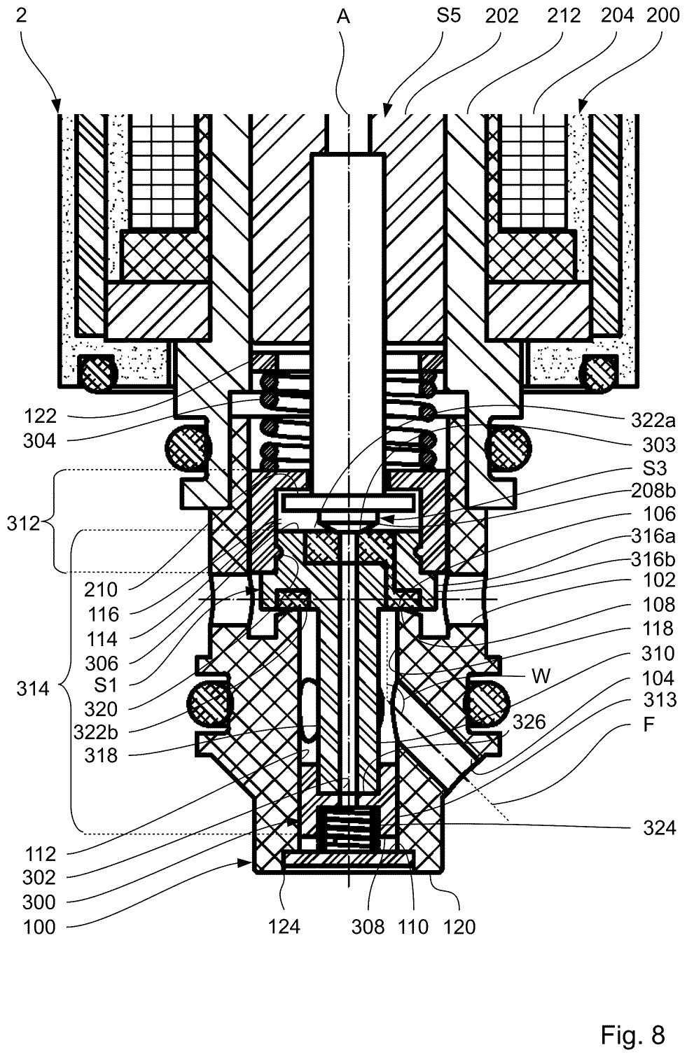

FIG. 8 shows a further single flow control valve 2, for which reason every feature in FIG. 8 is not described again. Only the differences from FIGS. 5 to 7 are to be described with regard to FIG. 8. Features which have already been described but are not repeated again are intended as it were to be considered disclosed and described. FIG. 8 shows the closed state of the flow control valve 2, in an analogous manner to FIGS. 1 and 5.

The pressure equalization space bounding portion 313 is arranged on the fluid conducting portion, but the parts bear loosely against one another. They are held together by way of a fastening spring 324 which presses the two parts together. Furthermore, the pressure equalization space bounding portion 313 is configured as a sleeve with an inner flange 326. The inner flange 326 delimits the pilot control bore 302 and bears against the end side of the fluid conducting portion 314.

The invention is not restricted to one of the above-described embodiments, but rather can be modified in a wide variety of ways. All of the features and advantages which are apparent from the claims, the description and the drawing, including structural details, spatial arrangements and method steps, can be essential to the invention both per se and in a very wide variety of combinations.

All combinations of at least two of the features disclosed in the description, the claims and/or the figures fall within the scope of the invention.

In order to avoid repetitions, features which are disclosed in accordance with the device are intended to also be considered as disclosed and claimable in accordance with the method. Features disclosed in accordance with the method are likewise also to be considered as disclosed and claimable in accordance with the apparatus.

### LIST OF REFERENCE SIGNS

2 Valve
100 Valve part
102 Inlet
104 Outlet
106 Valve seat
108 Main nozzle
110 Pressure equalization space
112 Bore
114 Valve part interior space
116 Pilot control space
118 Main flow space
120 Wall
122 Flange ring
200 Electromagnet
202 Armature
204 Coil
206 Armature preloading unit
208a Pilot control bore sealing device
208b Pilot control bore sealing device
210 Driving element
212 Core
300 Tappet
302 Pilot control bore
303 Pilot control nozzle
304 Tappet preloading device
306 First pressure surface
308 Second pressure surface
310 Annular channel
312 Driving portion
313 Pressure equalization space bounding portion
314 Fluid conducting portion
316a Top coat portion
316b Circular ring portion
318 Trunk portion
320 Clip-on connection
322a First annular seal
322b Second annular seal
324 Fastening spring
326 Inner flange
A Longitudinal axis
F Fluid path
S1 Closed position (of the tappet)
S2 Open position (of the tappet)
S3 Contact position (of the pilot control bore sealing device)
S4 Opening position (of the pilot control bore sealing device)
S5 Rest position (of the armature)
S6 Intermediate position (of the armature)
S7 End position (of the armature)
S8 Separation position (of the tappet)
W Angle

Although the present disclosure and its advantages have been described in detail, it should be understood that various changes, substitutions, and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. An electromagnetically actuable flow control valve having a central longitudinal axis, comprising:
a valve part having an inlet and an outlet;
a valve seat enclosing a main nozzle and arranged in flow terms between the inlet and the outlet in the valve part;
an armature arranged to move linearly along the central longitudinal axis;
a coil energized selectively to generate a magnetic field for moving the armature along the central longitudinal axis;
an armature preloading device;
a tappet comprising a pilot control bore with a pilot control nozzle, wherein the tappet is arranged adjustably in the valve part to move linearly along the central longitudinal axis between a closed position and an open position, wherein the tappet and the armature move relative to one another;
a pressure equalization space which is delimited by the tappet, wherein the pilot control bore connects the inlet fluidically to the pressure equalization space; and
a pilot control bore sealing device that moves with the armature to close the pilot control bore in a contact position with the pilot control nozzle and to open the pilot control bore in an opening position;
wherein the tappet closes the main nozzle in the closed position, wherein only the pilot control bore connects the inlet to the pressure equalization space, and wherein the tappet is spaced apart from the valve seat in the open position;
wherein the armature preloading device exerts a force on the armature, wherein the force preloads the armature preloading device into a rest position, in which the armature transmits the force to the pilot control bore sealing device and presses the pilot control bore sealing device into the contact position;
wherein the armature has a driving element which, when the armature moves out of the rest position into an intermediate position, the driving element engages with the tappet after the opening position of the pilot control bore sealing device is reached;
wherein, when the armature moves out of the intermediate position, the driving element moves the tappet out of the closed position into the open position.

2. The electromagnetically actuable flow control valve according to claim 1, wherein the pressure equalization space is only fluidically connected to the pilot control bore.

3. The electromagnetically actuable flow control valve according to claim 2, wherein the pilot control bore has only two openings.

4. The electromagnetically actuable flow control valve according to claim 1, wherein the pilot control bore has only two openings.

5. The electromagnetically actuable flow control valve according to claim 1, wherein the pressure equalization space is configured exclusively by the tappet and the valve part.

6. The electromagnetically actuable flow control valve according to claim 5, wherein the pressure equalization space is configured by the valve part by a single-piece portion of the valve part.

7. The electromagnetically actuable flow control valve according to claim 1, wherein the pressure equalization space is delimited without sealing devices.

8. The electromagnetically actuable flow control valve according to claim 1, wherein the valve part has a bore with a constant diameter along the central longitudinal axis on a side of the main nozzle where the pressure equalization space is present.

9. The electromagnetically actuable flow control valve according to claim 1, wherein the tappet has a first pressure surface which is exposed to a first fluidic pressure which prevails from the inlet.

10. The electromagnetically actuable flow control valve according to claim 9, wherein the tappet has a second pressure surface which is exposed to a second fluidic pressure which prevails from the pressure equalization space.

11. The electromagnetically actuable flow control valve according to claim 1, wherein the tappet has a pressure surface which is exposed to a fluidic pressure which prevails from the pressure equalization space.

12. The electromagnetically actuable flow control valve according to claim 1, wherein, on an outer circumferential side, the tappet has an annular channel which, in the open position, connects the inlet to the outlet.

13. The electromagnetically actuable flow control valve according to claim 12, wherein the annular channel connects the inlet to the outlet in the open position.

14. The electromagnetically actuable flow control valve according to claim 1, wherein the tappet has a circular ring portion which divides a valve part interior space into a pilot control space and a main flow space.

15. The electromagnetically actuable flow control valve according to claim 14, wherein the circular ring portion is adjusted by the tappet with respect to the inlet in such a way that it selectively opens a first fluidic connection between the inlet and the pilot control space, and disconnects a second fluidic connection between the inlet and the outlet through the main flow space.

16. The electromagnetically actuable flow control valve according to claim 14, wherein the circular ring portion is adjusted by the tappet with respect to the inlet in such a way that it selectively disconnects a first fluidic connection between the inlet and the pilot control space) or at least reduces a throughflow in comparison with an opened state, and opens a second fluidic connection between the inlet and the outlet through the main flow space.

17. The electromagnetically actuable flow control valve according to claim 1, wherein the tappet supports a first annular seal which serves to seal the pilot control nozzle, and wherein the tappet supports a second annular seal which serves to seal the main nozzle.

18. The electromagnetically actuable flow control valve according to claim 1, wherein the tappet is configured in one piece.

19. The electromagnetically actuable flow control valve according to claim 1, wherein the tappet is configured in multiple pieces.

20. The electromagnetically actuable flow control valve according to claim 1, wherein a tappet preloading device preloads the tappet into its closed position.
